(19) United States
(12) Patent Application Publication
(10) Pub. No.: US 2013/0100477 A1
(43) Pub. Date: Apr. 25, 2013

(54) SERVER APPARATUS, CLIENT APPARATUS, INFORMATION PROCESSING METHOD, AND PROGRAM

(71) Applicant: CANON KABUSHIKI KAISHA, Tokyo (JP)

(72) Inventor: Hiroshi Ozaki, Kawasaki-shi (JP)

(73) Assignee: CANON KABUSHIKI KAISHA, Tokyo (JP)

(21) Appl. No.: 13/657,696

(22) Filed: Oct. 22, 2012

(30) Foreign Application Priority Data
Oct. 24, 2011 (JP) 2011-233101

(51) Int. Cl. G06K 15/02

(52) U.S. Cl. 358/1.13

(57) ABSTRACT

A method and apparatus for controlling the use of a service includes receiving an acquisition request, including user identification information identifying a user, for service identification information identifying a usable service, specifying, based on the user identification information included in the acquisition request, service identification information identifying a service that can be used by the user identified by the user identification information, transmitting the specified service identification information, and transferring, when a print request including the service identification information and print data is received, the print data to a service identified by the service identification information.

### BACKGROUND OF THE INVENTION

1. Field of the Invention

Aspect of the present invention relate to a server apparatus, a client apparatus, an information processing method, and a program.

2. Description of the Related Art

When outputting from a computer apparatus to an image output device connected to a network, a printer driver suited to the image output device is installed in the computer apparatus, and a port to which the image output device is connected is set as an output port. By setting in this manner, a user can transmit image data to the image output device from the printer driver installed in the computer apparatus, and output that image data. With the spread of cloud services, the user can now store and process image data by transmitting output image data to a cloud service server apparatus in the cloud. Image data transmitted to the cloud server can be output to a designated image output device and acquired from the image output device by connecting to a cloud service server apparatus.

When setting a cloud service server apparatus provided in the cloud as a printer driver output destination, there are concerns that need to be addressed. First, if the output destination is an image output device, the output destination can be automatically set by searching for the image output device. However, for a cloud service server apparatus, the server apparatus cannot be found and specified, and thus it is typically the user's responsibility to acquire connection destination information about the cloud service server apparatus, such as a connection destination address, an account, or a password, and manually register that connection destination information. Further, if the user permits output to a cloud service that the user has registered, the user can no longer manage the user's usage state. To address this, it is necessary to enable information about a usable cloud service to be set as an output destination by transmitting the information to the computer apparatus that the user is using, and to manage the usage state of the cloud service by performing unitary management of output to the cloud service. Japanese Patent Application Laid-Open No. 2010-271988 discusses a technology which manages links to output destinations based on the user, and changes the output destination based on that management information, but is not seen to address the above-described concerns.

### SUMMARY OF THE INVENTION

Aspects of the present invention relate to enabling a user to set a cloud service as an output destination with a client apparatus, and enabling a usage state of the cloud service by the user to be managed.

According to an aspect of the present invention, an apparatus includes a memory and a processor, the processor configured to control a reception unit configured to receive an acquisition request, including user identification information identifying a user, for service identification information identifying a usable service from a client apparatus, a specification unit configured, based on the user identification information included in the acquisition request, to specify service identification information identifying a service that can be used by the user identified by the user identification information, a transmission unit configured to transmit the service identification information to the client apparatus, and a transfer unit configured to, when a print request including the service identification information and print data is received from the client apparatus, transfer the print data to a service identified by the service identification information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a schematic configuration of a printing system.

FIG. 2 illustrates an example of a configuration of a computer apparatus 103 and an image output device 102.

FIG. 3 illustrates an example of a configuration of a cloud service server apparatus 101.

FIG. 4 illustrates an example of a configuration of a computer management server apparatus 104.

FIG. 5 illustrates an example of a function configuration of a software realized when a cloud service management program 483 is executed on the computer management server apparatus 104.

FIG. 6A illustrates an example of a table for managing usable cloud services associated with user identification information.

FIG. 6B illustrates an example of a log.

FIG. 7A illustrates an example (part 1) of a driver UI.

FIG. 7B illustrates an example (part 2) of a driver UI.

FIG. 8 is a flowchart illustrating an example of registration of cloud service information.

FIG. 9A is a flowchart illustrating an example of the initial setting processing of a printer driver.

FIG. 9B is a flowchart illustrating an example of cloud information transmission processing performed by a computer management server apparatus.

FIG. 10A is a flowchart illustrating an example of output setting processing to a cloud service.

FIG. 10B is a flowchart illustrating an example of output processing to a cloud service.

### DESCRIPTION OF THE EMBODIMENTS

Various exemplary embodiments, features, and aspects of the invention will be described in detail below with reference to the drawings.

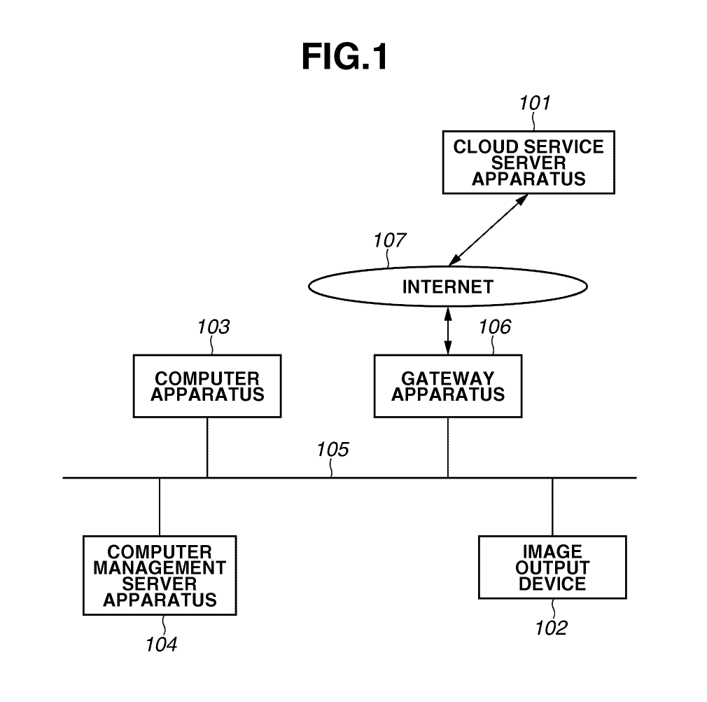

A first exemplary embodiment will now be described. FIG. 1 illustrates an example of a schematic configuration of a printing system. The printing system according to the present exemplary embodiment includes a computer apparatus 103 operated by a user, an image output device 102 that receives and outputs print jobs, and a computer management server apparatus 104 that manages the computer apparatus 103. These devices are connected to each other via a network 105, which is configured, for example, from a local area network (LAN). The devices are also connected to a cloud service server apparatus 101 over the Internet 107 via a gateway apparatus 106 that is on the network 105. The image output device 102 receives print jobs generated by the computer apparatus 103 via the network 105, and prints the received jobs. In addition, the image output device 102 can also receive jobs from the cloud service server apparatus 101, and print those jobs.

The cloud service server apparatus 101 can, for example, receive image data via the Internet 107, and edit the image data based on an instruction from the user. The image data stored on the cloud service server apparatus 101 may be output to an image output device designated by the user or output based on a request from the image output device. The computer management server apparatus 104 manages the usage state of the computer apparatus 103. In the present exemplary embodiment, the computer management server apparatus 104 manages users who are logged in to the computer apparatus 103, manages the cloud services used by the users, and transmits information as necessary. The computer apparatus 103 is an example of a client apparatus. The computer management server apparatus 104 is an example of a server apparatus. The computer apparatus 103 and the computer management server apparatus 104 are communicably connected as described above via a network.

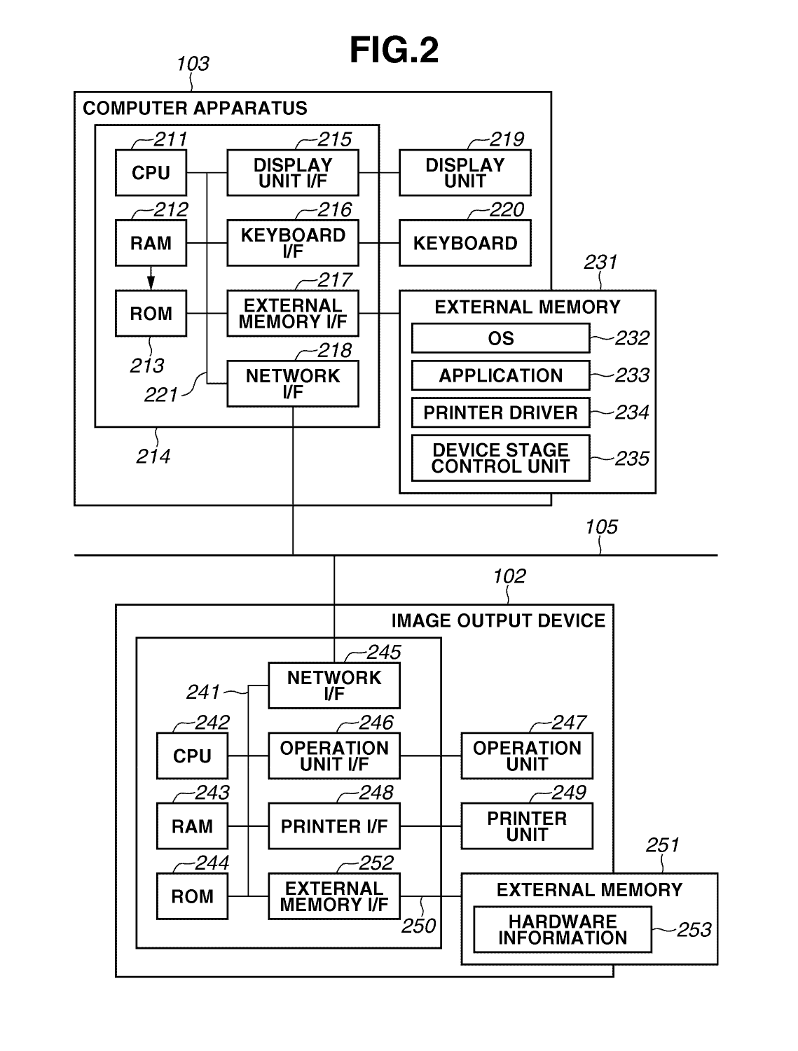

FIG. 2 illustrates an example of a configuration of the computer apparatus 103 and the image output device 102. A central processing unit (CPU) 211 controls in an integrated manner each device connected to a system bus 221 based on programs stored in a random access memory (RAM) 212. The RAM 212 functions as a main memory and a work area for the CPU 211. A read-only memory (ROM) 213 stores various programs and data. A keyboard controller I/F 216 controls inputs from a keyboard 220 or a pointing device (touch panel etc.) (not illustrated). A display unit I/F 215 controls the display on a display unit 219. An external memory I/F 217 controls access to an external memory 231, such as a flash memory or a solid state disk (SSD). The external memory 231 functions as a storage medium for storing an operating system (OS) 232, various applications 233, a printer driver 234, and a device stage control unit 235. This data can be stored in or read from the external memory 231 by the computer apparatus 103. A network I/F 218 is a network control unit that enables connection to the network 105 via a network terminal. The functions of the computer apparatus 103 and the processing performed in the respective steps of the information processing flowchart by the computer apparatus 103 are realized by the CPU 211 executing processing based on a program. The printer driver 234 is an example of an image output device control unit.

Next, the configuration of the image output device 102 will be described. A CPU 242 controls operation of the entire image output device 102. A RAM 243 functions as a main memory and a work area for the CPU 242, and is also used as an image information rasterization region and an environment data storage region. Further, the RAM 243 also includes a non-volatile RAM (NVRAM) area, and is configured so that its memory capacity can be expanded with an optional RAM connected to an expansion port (not illustrated). A ROM 244 stores various kinds of fonts, control programs executed by the CPU 242, and various kinds of data. A network I/F 245 transmits and receives data to/from the computer apparatus 103. A printer I/F 248 controls an interface with a printer unit 249, which is a printer engine. An external memory I/F 252 controls access to an external memory 251. The external memory 251 includes a flash memory or a SSD, for example, and can store hardware information 253.

If the external memory 251 is not connected, the hardware information 253 is stored in the ROM 244. An operation unit I/F 246 controls an interface with an operation unit 247 that sets scan processing of the image output device 102. The operation unit 247 is provided with an operation panel for receiving operations from the user. Switches and a light-emitting diode (LED) display device for operation are arranged on the operation panel. Further, the operation unit 247 may include a NVRAM (not illustrated), and store print setting information from the operation panel.

The CPU 242 can perform communication processing with the computer apparatus 103 via the network I/F 245 to receive print jobs from the computer apparatus 103. In addition, the CPU 242 is configured so that it can notify the computer apparatus 103 about information in the image output device 102. In the present exemplary embodiment, a service protocol is implemented on the network I/F 245. Further, a plurality of protocols even as the protocol for receiving the print jobs is implemented on the network I/F 245. Examples thereof include Line Printer Daemon protocol (LPR) and Port9100, which can receive print jobs over a local network, and Internet printing protocol (IPP) that is suited to print job reception via the Internet. The CPU 242 transmits image data to a printer unit 249 via the printer I/F 248 and executes printing based on a control program stored in the ROM 244. The functions of the image output device 102 are realized by the CPU 242 executing processing based on a program.

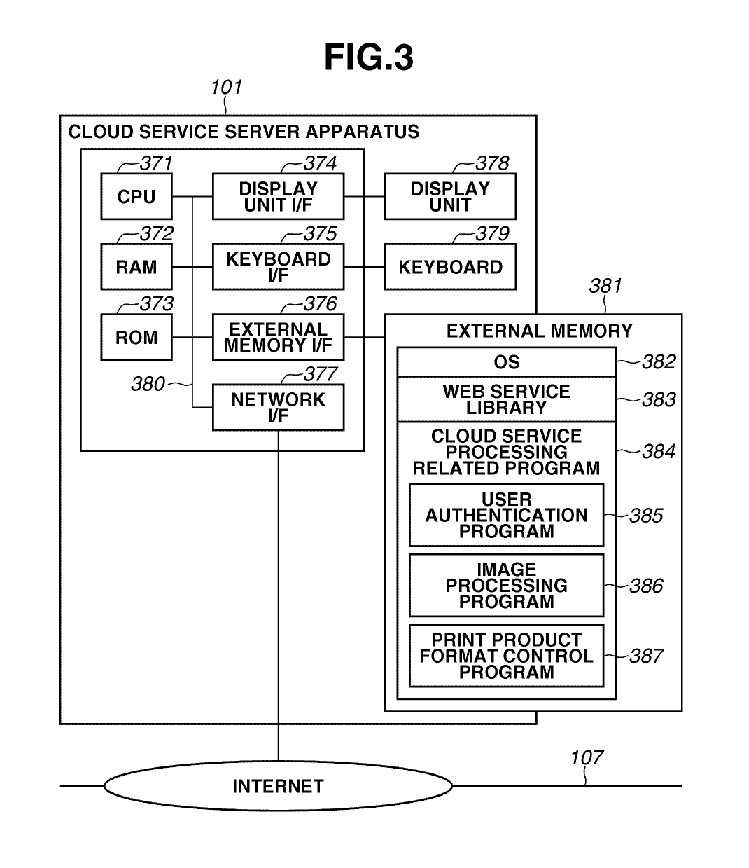

FIG. 3 illustrates an example of a configuration of the cloud service server apparatus 101. A CPU 371 controls in an integrated manner each device connected to a system bus 380 based on programs stored in a RAM 372. The RAM 372 functions as a main memory and a work area for the CPU 371. A ROM 373 stores various programs and data. A keyboard controller I/F 375 controls inputs from a keyboard 379 or a pointing device (e.g., a mouse) (not illustrated). A display unit I/F 374 controls the display on a display unit 378. An external memory I/F 376 controls access to an external memory 381, such as a hard disk (HD) or an SSD.

The external memory 381 includes an OS 382, a web service library 383, and a cloud service processing related program 384. The cloud service processing related program 384 includes a user authentication program 385, an image processing program 386, a print product format control program 387, and a rendering program 388. The network I/F 377 is connected to the computer apparatus 103, the computer management server apparatus 104, and the computer management server apparatus 104 via a network 107, and enables data transmission. The functions of the cloud service server apparatus 101 are realized by the CPU 371 executing processing based on a program.

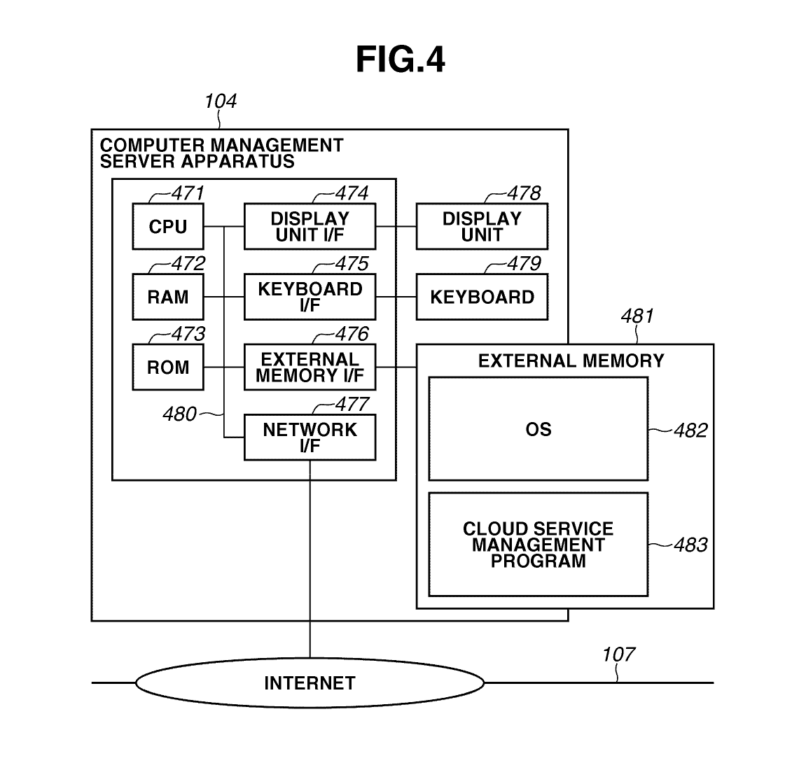

FIG. 4 illustrates an example of a configuration of the computer management server apparatus 104. A CPU 471 controls in an integrated manner each device connected to a system bus 480 based on programs stored in a RAM 472. The RAM 472 functions as a main memory and a work area for the CPU 471. A ROM 480 stores various programs and data. A keyboard controller I/F 475 controls inputs from a keyboard 479 or a pointing device (e.g., a mouse) (not illustrated). A display unit I/F 474 controls the display on a display unit 478. An external memory I/F 476 controls access to an external memory 481, such as a HD or a SSD. The external memory 481 includes an OS 482 and a cloud service management program 483 that manages the cloud services that can be utilized by the computer apparatus 103.

A network I/F 477 is connected to the computer apparatus 103 via the network 105, and indirectly performs communication control processing with the image output device 102. At the computer management server apparatus 104, the data to be transmitted can be controlled depending on the user who is logged in to the computer apparatus 103. In the present exemplary embodiment, cloud service information can be registered with the computer management server apparatus 104. Examples of this cloud service information include the names of the cloud services that can be used by each user, connection destination information about the cloud services, account/password information for cloud service authentication, and the corresponding file format. The functions of the computer management server apparatus 104 and the processing performed in the respective steps of the information processing flowchart by the computer management server apparatus 104 are realized by the CPU 471 executing processing based on a program.

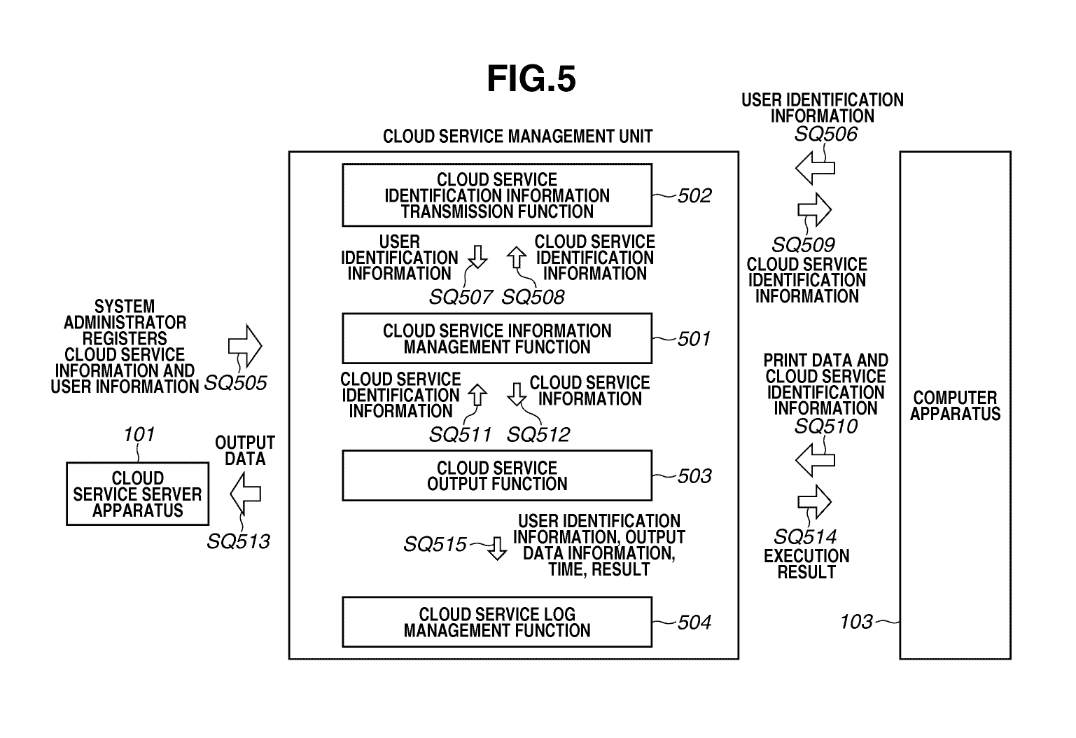

FIG. 5 illustrates an example of a function configuration of a software realized when the cloud service management program 483 is executed on the computer management server apparatus 104. A cloud service management unit includes a cloud service information management function 501, a cloud service identification information transmission function 502, a cloud service output function 503, and a cloud service log management function 504. The cloud service information management function 501 registers information about the usable cloud services and manages the cloud services that can be used by each user, and in sequence SQ505, registration is performed by the system administrator managing the entire system.

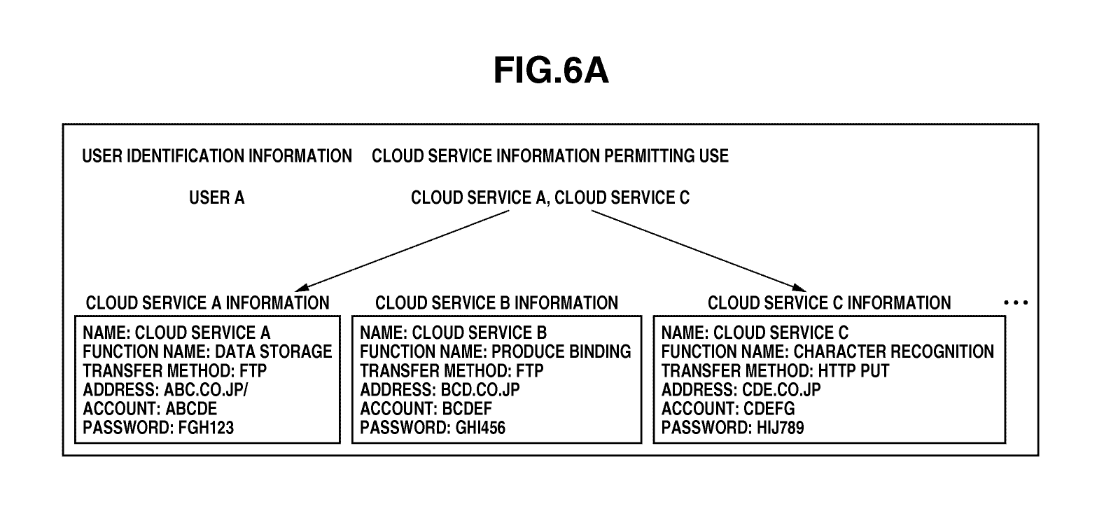

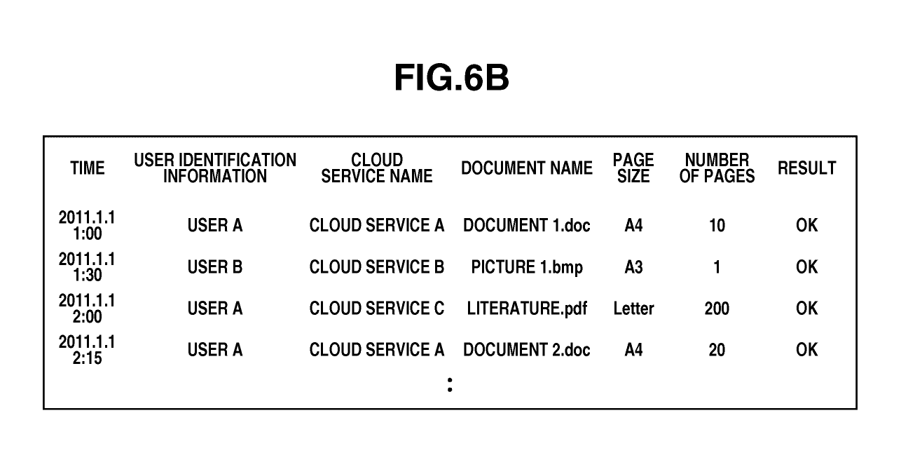

Examples of cloud service information that can be registered include a cloud service name, an address such as a URL for connection, an account, a password, and a file format supported by the cloud service. As the registration method, a mode in which a user interface (UI) (screen) is provided to enable inputs or a mode that reads a file described in a predetermined format maybe employed. Common examples of user identification information for managing the cloud services that can be used by each user include a login account of the OS in the computer apparatus 103, and when authenticating with an integrated chip (IC) card, a user account stored on the IC card. However, this information can be anything that identifies the user. FIG. 6A illustrates an example of a table for managing usable cloud services associated with user identification information. More specifically, the data illustrated in FIG. 6A is an example of cloud service information.

In sequence SQ506, an acquisition request for cloud service identification information including user identification information is transmitted from the computer apparatus 103. The cloud service identification information transmission function 502 receives the request. In sequence SQ507, the cloud service identification information transmission function 502 transfers the received user identification information to the cloud service information management function 501. Then, in sequence SQ508, the cloud service identification information transmission function 502 receives the name (cloud service name) of the cloud service that can be used by the user identified by the user identification information from the cloud service information management function 501. In sequence SQ509, the cloud service identification information transmission function 502 transmits the received cloud service name to the computer apparatus 103 as cloud service identification information. In the present exemplary embodiment, although a cloud service name is used as the cloud service identification information, any information may be used as long as such information is associated with the cloud service information.

Next, in sequence SQ510, output is instructed and a print request including the cloud service name is transmitted from the computer apparatus 103 and output data is transferred to the cloud service output function 503. The cloud service output function 503 receives the print request. In sequence SQ511, the cloud service output function 503 transfers the cloud service name included in the received print request to the cloud service information management function 501. Then, in sequence SQ512, the cloud service output function 503 acquires the information (i.e., connection destination information) necessary to transmit the output data to the cloud service from the cloud service information management function 501. In sequence SQ513, the cloud service output function 503 transmits the output data to the cloud service server apparatus 101.

Examples of the connection destination information necessary to transmit the output data to the cloud service include the cloud service address, an account, a password, a file transmission method, the file format to transmit, and the like. The cloud service output function 503 may also have a function of converting the format of the output data transferred from the computer apparatus 103 into a format supported by the cloud service. Further, the cloud service output function 503 may be configured to transfer the file format information corresponding to the cloud service to the computer apparatus 103 along with the cloud service identification information. In such a case, the output data is converted into a file format supported by the cloud service by a printer driver in the computer apparatus 103.

In sequence SQ514, the output data is transmitted by the cloud service output function 503 to the cloud service server apparatus 101, and the result is consequently transmitted to the computer apparatus 103. In sequence SQ515, the user identification output to the cloud service, output data information, time information, and information about the result and the like are also transmitted to the cloud service log management function 504. The cloud service log management function 504 records the received information as a log. As the output data information, the cloud service log management function 504 may store the print data itself, or may extract and manage a document name and number of pages, for example, from the print data. FIG. 6B illustrates a log management example when a document name, number of pages, and paper size are extracted from the print data. This log information can be referenced by the system administrator by providing the cloud service log management function 504 with a UI function, or can be transferred to a system that performs unitary management of the user usage state.

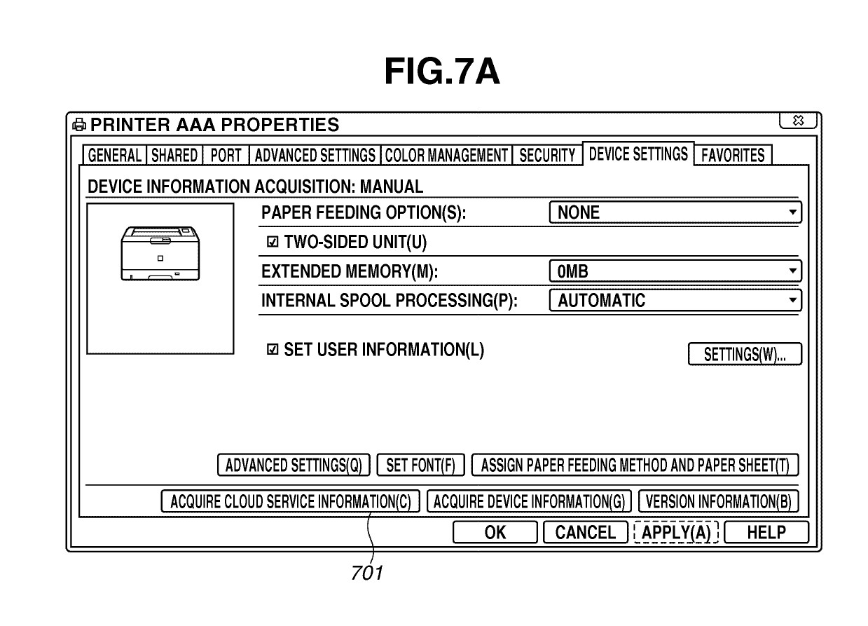

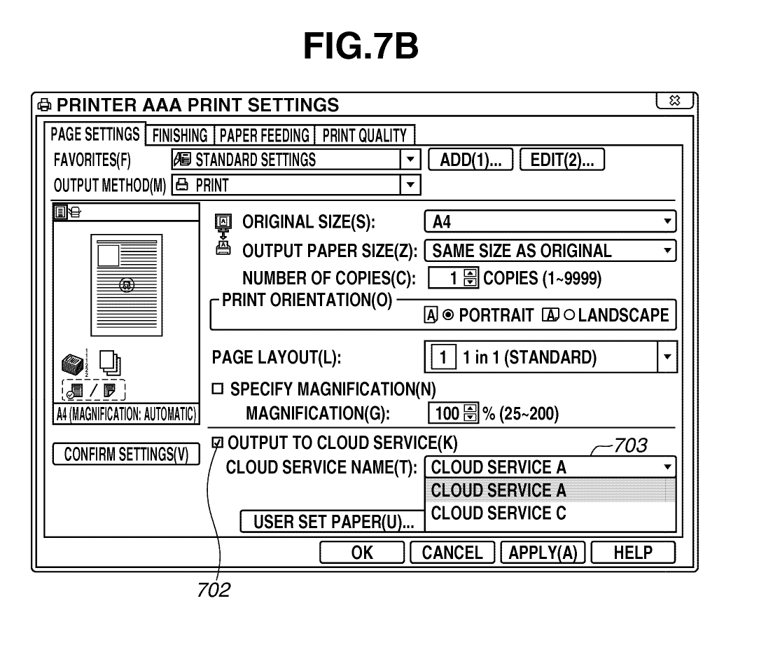

Next, an example of a printer driver UI installed in the OS on the computer apparatus 103 will be illustrated in FIGS. 7A and 7B. FIG. 7A illustrates an example of a UI when a printer property is displayed from a list of the printer drivers registered in the OS. In the example illustrated in FIG. 7A, a printer driver initial setting can be performed. When an “acquire cloud service information” function 701 is selected on the device setting sheet of this UI, the user identification information is transmitted to the computer management server apparatus 104, and an inquiry can be made about the cloud service identification information for the cloud service that can be used by the user. The kind of information used as the user identification information can be selected with the printer driver UI from among a login name to the OS, a manual setting, and a user ID authenticated based on IC card authentication. FIG. 7B illustrates an example of a printer driver UI displayed for the purpose of performing a print setting when printing from an application software. In the UI illustrated in FIG. 7A, acquiring information by selecting the “acquire cloud service information” function 701 enables “output to cloud service” 702 to be selected. When this function is selected, a cloud service names list 703 that can be selected is displayed, so that the cloud service to be output can be designated.

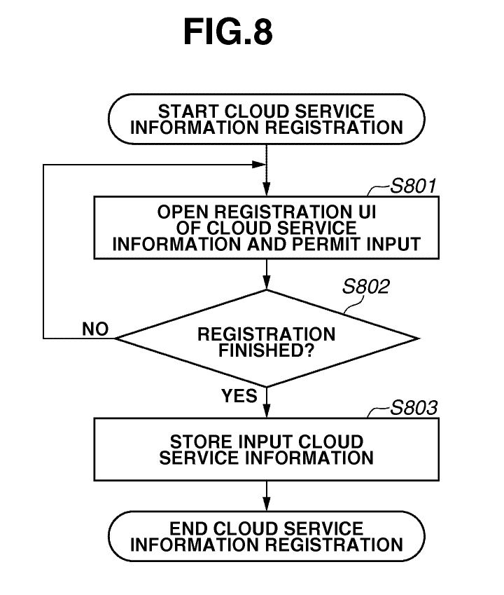

The flow of the series of information processing steps according to the present exemplary embodiment will now be described with reference to FIGS. 8, 9A, 9B, 10A, and 10B. First, the control for registering information about the usable cloud services associated with the user identification information in the computer management server apparatus 104 performed by the system administrator will be described with reference to the flowchart of FIG. 8. The cloud service information can be registered by the cloud service information management function 501 on the computer management server apparatus 104. As the registration method, although a mode in which a UI is provided to enable inputs or a mode that reads a file described in a predetermined format may be employed, in the present exemplary embodiment, a mode is employed in which a UI (not illustrated) for inputting information is displayed, and the inputs are enabled. In step S801, the cloud service information management function 501 displays a registration UI for cloud service information, and permits inputs.

In step S802, if all inputs are complete (YES in step S802), the processing proceeds to step S803. In step S803, the cloud service information management function 501 stores the input cloud service information. The cloud service information may include the cloud service name, an address such as a URL for connection, an account, a password, and a file format supported by the cloud service. Further, although cloud service identification information for identifying this cloud service can also be registered, in the present exemplary embodiment, the cloud service name will be used. User identification information can also be registered, which allows the cloud services that can be used by each user to be managed. Representative examples of the user identification information include a login account of the OS in the computer apparatus 103, and when authenticating with an IC card, a user account stored on the IC card. However, any information may be used as long as it can identify the user.

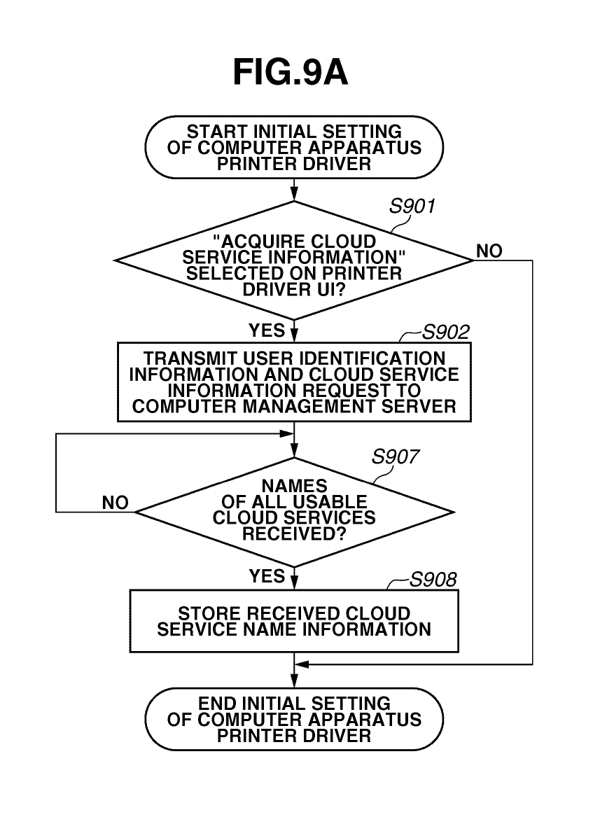

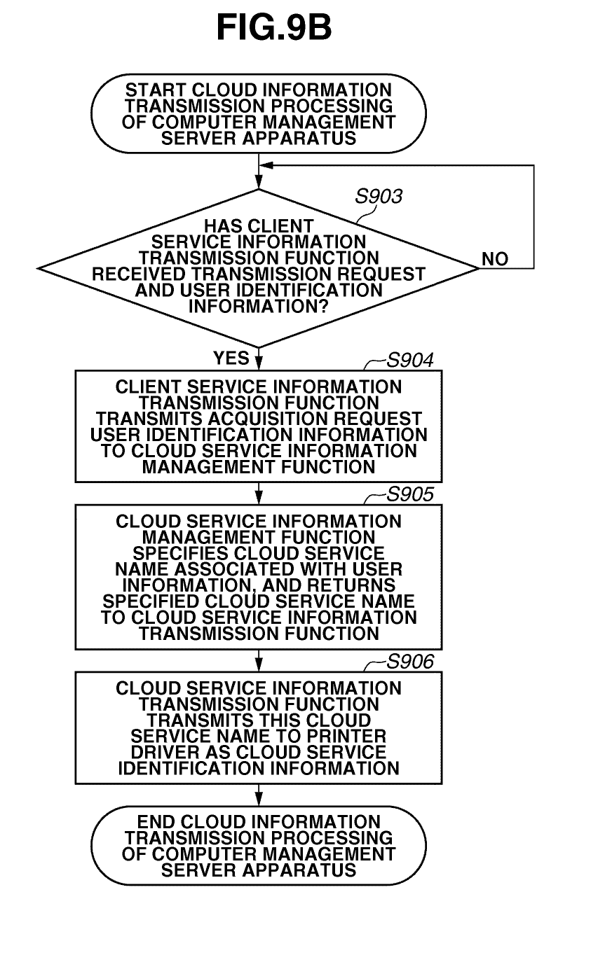

Next, the flow of the information processing for requesting cloud service identification information about usable cloud services from the printer driver on the computer apparatus 103 and transmitting this information from the computer management server apparatus 104 will be described with reference to FIGS. 9A and 9B. A printer driver for performing print setting, converting print data into a desired format, and adding management information about the user when printing print data from an application software is installed in the computer apparatus 103. As illustrated in FIGS. 7A and 7B, the printer driver includes a function of acquiring the cloud service identification information about usable cloud services and a function of displaying a list of the acquired cloud service identification information to let the user make a selection. Although not illustrated, the address for connecting to the computer management server apparatus 104 from the computer apparatus 103 may be determined in advance, or the address may be registered in the computer apparatus 103. Further, this function can be realized based on communication between the computer apparatus 103 and the image output device 102 by making the image output device 102 have the functions of the computer management server apparatus 104.

In step S901, if the printer driver detects that the “acquire cloud service information” function 701 is selected by the user on the printer driver UI illustrated in FIG. 7A (YES in step S901), the processing proceeds to step S902. In step S902, the printer driver transmits an acquisition request for the cloud service identification information including user identification information to identify a cloud service, to the computer management server apparatus 104. In step S903, if the cloud service identification information transmission function 502 on the computer management server apparatus 104 receives this acquired request (YES in step S903), the processing proceeds to step S904.

In step S904, the cloud service identification information transmission function 502 transmits the user identification information included in the acquisition request to the cloud service information management function 501. In step S905, the cloud service information management function 501 specifies the name of a cloud service that can be used by this user from a table like that illustrated in FIG. 6A, and returns the specified name to the cloud service identification information transmission function 502. In step S906, the cloud service identification information transmission function 502 transmits this cloud service name as cloud service identification information to the printer driver on the computer apparatus 103 that made the acquisition request. In step S907, if the printer driver has received the cloud service identification information that identifies all of the cloud services that can be used by the user, i.e., has received all of the names of the usable cloud services (YES in step S907), the processing proceeds to step S908. In step S908, the printer driver registers the cloud service names. At this stage, the printer driver may also receive information about file formats supported by the cloud services from the cloud service identification information transmission function 502, and register that information. If this information is registered, the printer driver can generate output data in a file format suited to the output cloud service.

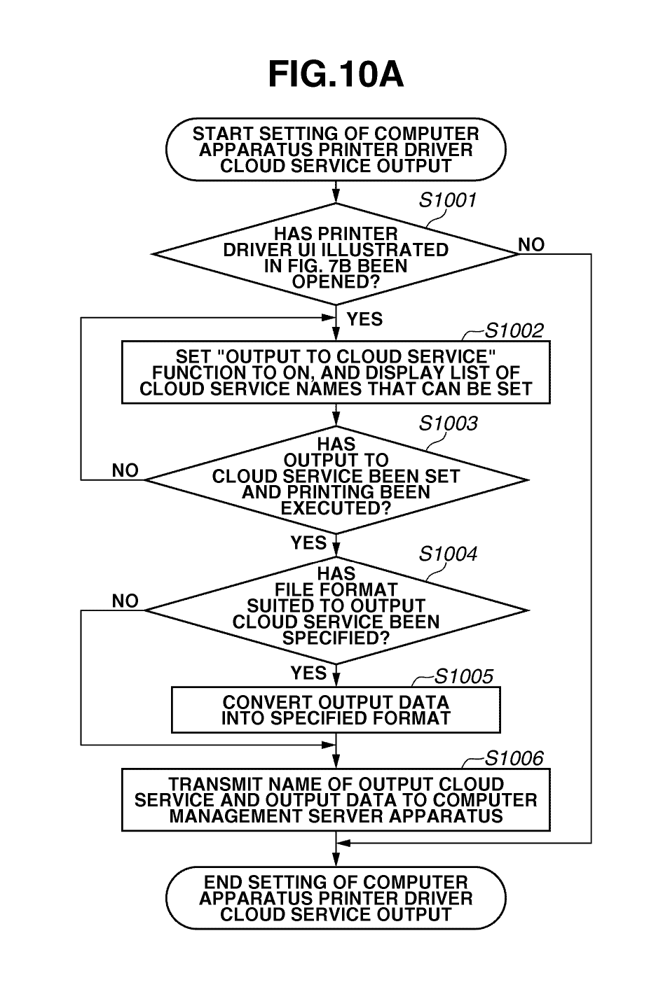

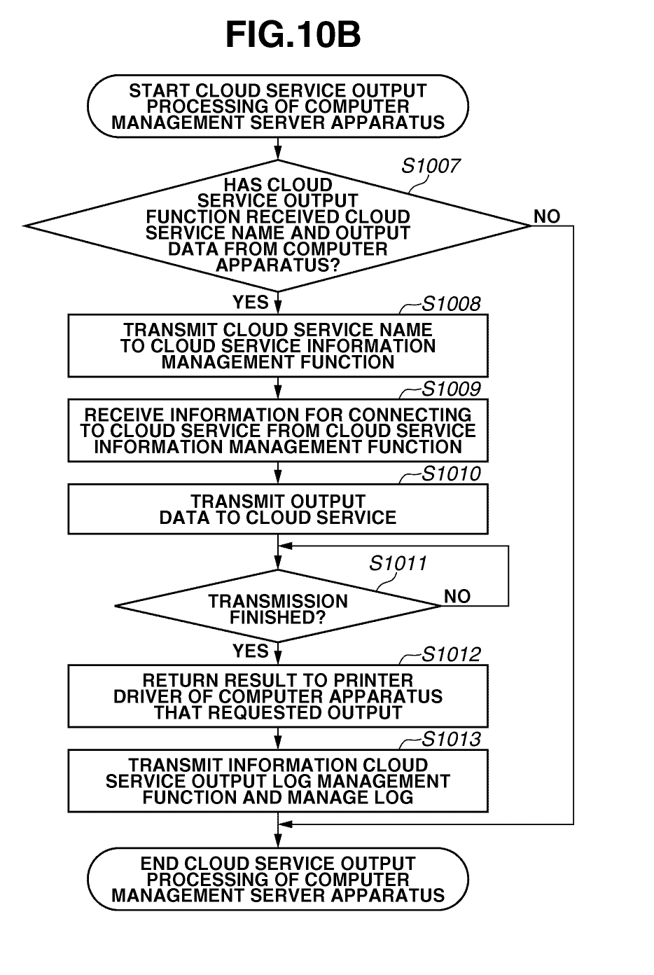

Next, the processing flow of printing when the user on the computer apparatus 103 designates a cloud service will be described with reference to the flowcharts of FIGS. 10A and 10B. If the printer driver detects that the printer driver UI for performing print setting when performing printing has been opened by the user (YES in step S1001), the processing proceeds to step S1002. In step S1002, as illustrated in FIG. 7B, the printer driver enables the “output to cloud service” function and the output cloud service name to be specified.

In step S1003, if the output cloud service name has been specified and printing executed (YES in step S1003), the processing proceeds to step S1004. In step S1004, the printer driver determines whether there is information about the file format supported by the cloud service. If it is determined that there is information about the file format supported by the cloud service (stored in the memory etc.) (YES in step S1004), the processing proceeds to step S1005. In step S1005, the printer driver converts the output data into that format. Then, in step S1006, the printer driver transmits a print request including the name of the output cloud service and the output data to the computer management server apparatus 104. If there is no format information (NO in step S1004), the printer driver transmits the output data in a predetermined format.

In step S1007, if the cloud service output function 503 of the computer management server apparatus 104 receives a print request that includes the cloud service name and the output data (YES in step S1007), the processing proceeds to step S1008. In step S1008, the cloud service output function 503 transmits the cloud service name to the cloud service information management function 501. In step S1009, the cloud service output function 503 acquires the information for outputting to the cloud service (cloud service connection information) from the cloud service information management function 501. In step S1010, by using the cloud service connection information, the cloud service output function 503 transmits the output data to the cloud service server apparatus 101 based on a file transfer protocol supported by the cloud service.

In step S1011, if transmission is complete (YES in step S1011), the processing proceeds to step S1012. In step S1012, the cloud service output function 503 notifies the printer driver in the computer apparatus 103 of the transmission result. Further, the cloud service output function 503 notifies the cloud service log management function 504 in the computer management server apparatus 104 of the user information, the output data information, and the time information. Then, in step S1013, the received information is recorded as a log by the cloud service log management function 504. As the output data information, the print data itself may be stored, or a document name and number of pages, for example, may be extracted and managed from the print data.

In the above exemplary embodiment, the image output device 102 and the computer management server apparatus 104 are provided separately. However, the cloud service management program 483 of the computer management server apparatus 104 may be provided on the image output device 102. In this case, first, the usable cloud service information can be registered in the image output device 102 for each piece of user identification information. Further, when the acquisition request for cloud service identification information about the usable cloud services including user identification information is transmitted from the printer driver to the image output device 102, the image output device 102 returns the usable cloud service identification information. In addition, when a print request including the cloud service identification information and the output data to be output from the printer driver to the image output device 102 is transmitted, the image output device 102 retrieves cloud service connection information from the cloud service identification information. Moreover, the image output device 102 connects to the cloud service using the cloud service connection information, and transfers the output data. When transmission is complete, the image output device 102 records that result in the log, and enables the usage state of the user's cloud service to be managed.

The present invention can also be realized by supplying software (a program) for realizing the functions of the above exemplary embodiment to a system or an apparatus via a network or via various storage media, and having a computer (a CPU or a micro processing unit (MPU)) of the system or apparatus read and execute the program.

According to the above exemplary embodiments, the need to manage a URL or other such address, an account, or a password in order to connect to a cloud service is eliminated even when a user outputs print data to a cloud service. Further, the usable cloud services can be managed on an individual user basis, and the usage state of cloud services by users can be managed by enabling outputs to the cloud services to be performed unitary management at the server side. Specifically, according to the above exemplary embodiments, the user can set a cloud service as an output destination at a client apparatus, and can manage the usage state of the cloud service by the user. Further, according to the above exemplary embodiments, the user of the computer apparatus 103 selects a cloud service on a printer driver UI like that illustrated in FIGS. 7A and 7B that the user is familiar with, and the user can request output.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-233101 filed Oct. 24, 2011, which is hereby incorporated by reference herein in its entirety.

What is claimed is:

1. An apparatus comprising:
a memory; and
a processor, the processor configured to control:
a reception unit configured to receive an acquisition request, including user identification information identifying a user, for service identification information that identifies a usable service from a client apparatus;
a specification unit configured to, based on the user identification information included in the acquisition request, specify service identification information identifying a service that can be used by the user identified by the user identification information;
a transmission unit configured to transmit the service identification information to the client apparatus; and
a transfer unit configured to, when a print request including the service identification information and print data is received from the client apparatus, transfer the print data to a service identified by the service identification information.

2. The apparatus according to claim 1, wherein the processor is further configured to control a registration unit configured to register user identification information identifying a user and service identification information identifying a service that can be used by the user identified by the user identification information in a storage device as service information,
wherein the specification unit is configured, based on the user identification information included in the acquisition request, to specify the service identification information identifying a service that can be used by the user identified by the user identification information included in the acquisition request from the service information.

3. The apparatus according to claim 1, wherein the processor is further configured to control a registration unit configured to register user identification information identifying a user, service identification information identifying a service that can be used by the user identified by the user identification information, and connection destination information for connecting to the service in a storage device as service information,
wherein the transfer unit is configured, when a print request including the service identification information and print data are received from the client apparatus, based on the service identification information, to acquire connection destination information about a service identified by the service identification information from the service information, connect to the service based on the acquired connection destination information, and transfer the print data to the service.

4. The apparatus according to claim 1, wherein the processor is further configured to control a log management unit configured to manage print data included in the print request, the user identification information, and time information as a log.

5. The apparatus according to claim 1, wherein the client apparatus includes a processor configured to control an image output device control unit configured to control an image output device,
wherein the reception unit is configured to receive the acquisition request from the image output device control unit,
wherein the transmission unit is configured to transmit the service identification information to the image output device control unit, and
wherein the transfer unit is configured, when a print request including the service identification information and print data is received from the image output device control unit, to transfer the print data to the service identified by the service identification information.

6. The apparatus according to claim 5, wherein the apparatus is an image output device.

7. A client apparatus comprising:
a memory; and
a processor, the processor configured to control:
a transmission unit configured to transmit an acquisition request, including user identification information identifying a user, for service identification information identifying a usable service to a server apparatus;
a reception unit configured to receive the service identification information;
a display unit configured to selectably display a service identified by the service identification information;
wherein, when a service displayed by the display unit is selected, print data is transmitted to the selected service.

8. A control method comprising:
receiving an acquisition request, including user identification information identifying a user, for service identification information identifying a usable service;
specifying, based on the user identification information included in the acquisition request, service identification information identifying a service that can be used by the user identified by the user identification information;
transmitting the specified service identification information; and
transferring, when a print request including the service identification information and print data is received, the print data to a service identified by the service identification information.

9. The control method according to claim 8, further comprising registering user identification information identifying a user and service identification information identifying a service that can be used by the user identified by the user identification information in a storage device as service information,
wherein, based on the user identification information included in the acquisition request, the service identification information identifying a service that can be used by the user identified by the user identification information included in the acquisition request is further specified from the service information.

10. The control method according to claim 8, further comprising registering user identification information identifying a user, service identification information identifying a service that can be used by the user identified by the user identification information, and connection destination information for connecting to the service in a storage device as service information,
wherein, when a print request including the service identification information and print data are received, based on the service identification information, connection destination information about a service identified by the service identification information is acquired from the service information, the service is connected to based on the acquired connection destination information, and the print data is transferred to the service.

11. The control method according to claim 8, further comprising managing print data included in the print request, the user identification information, and time information as a log.

12. A client control method comprising:
transmitting an acquisition request, including user identification information identifying a user, for service identification information identifying a usable service;
receiving the service identification information; and
selectably displaying a service identified by the received service identification information;
wherein when a displayed service is selected, print data is transmitted to the selected service.
